(19) United States
(12) Patent Application Publication
(10) Pub. No.: US 2021/0280108 A1
(43) Pub. Date: Sep. 9, 2021

(54) GOA CIRCUIT, ARRAY SUBSTRATE, AND DISPLAY DEVICE

(71) Applicant: SHENZHEN ROYOLE TECHNOLOGIES CO., LTD.

(72) Inventor: Ximeng GUAN, SHENZHEN (CN)

(73) Assignee: SHENZHEN ROYOLE TECHNOLOGIES CO., LTD., SHENZHEN, GD (CN)

(21) Appl. No.: 16/334,475

(22) PCT Filed: May 15, 2017
(86) PCT No.: PCT/CN2017/084397

§ 371 Date: Mar. 19, 2019

(51) Int. Cl. G09G 3/20

(52) U.S. Cl. CPC G09G 3/20; G09G 2310/08; G09G 2300/0408

(57) ABSTRACT

A GOA circuit including a number of GOA units in cascade. Each GOA unit is configured to work in a pre-charge stage, a bootstrap output stage, an output decreasing stage, a reset stage, a first holding stage, a second holding stage and a load-mitigating stage, and includes an enable input terminal configured to receive an enable input signal, a clock signal terminal configured to receive a clock signal, and an output terminal configured to output the scanning pulse signal according to the enable input signal and the clock signal when the GOA unit is in the pre-charge stage, the bootstrap output stage and the output decreasing stage, and configured to cut off outputting the scanning pulse signal when the GOA unit is in the reset stage, the first holding stage, the second holding stage and the load-mitigating stage.

### CROSS-REFERENCE TO RELATED APPLICATIONS

This application is a national phase application of International Application No. PCT/CN2017/084397, filed May 15, 2017, the entire contents of which are incorporated herein by reference.

### FIELD

The present disclosure relates to a display field, and more particularly to a gate driver on array (GOA) circuit, an array substrate and a display device.

### BACKGROUND

In recent years, a gate driver on array (GOA) circuit has been widely used in electronic displays such as a liquid crystal display (LCD) and an active-matrix organic light emitting diode (AMOLED). The GOA circuit is a key part of the display panel and is configured to provide a scanning pulse signal to a pixel matrix. The GOA circuit is typically designed in cascade. As resolution of a display panel is required to be gradually increased, the number of pixels per row is increased and a load required to be driven by the GOA unit of each level is increased accordingly, such that an output transistor with a larger size is required to be used in the GOA unit to provide a larger drive current when a scanning pulse signal is generated. However, as the size of the output transistor is increased, the parasitic coupling capacitance between the input terminal and the output terminal of the GOA unit is increased, such that pulse signal of an output clock may feed forward to the output terminal through the capacitor even when the output transistor is turned off. In such a case, an unnecessary, small floating may occur to the voltage of the output terminal, and may become larger after passing through GOA units in cascade. Accordingly, after passing some GOA units, the output transistors in certain level may all be turned on when trigger edges of all the pulses of the output clock signal reach, causing a false trigger, thus resulting in redundant or erroneous pulse output.

### SUMMARY

Embodiments of the present disclosure seek to solve at least one of the problems existing in the related art to at least some extent. Accordingly, embodiments of the present disclosure provide a GOA circuit, an array substrate and a display device.

Embodiments of the present disclosure provide a GOA circuit, configured to provide a scanning pulse signal to a pixel matrix, including a plurality of GOA units in cascade, in which each GOA unit is configured to work in a pre-charge stage, a bootstrap output stage, an output decreasing stage, a reset stage, a first holding stage, a second holding stage and a load-mitigating stage, and includes an enable input terminal configured to receive an enable input signal, a clock signal terminal configured to receive a clock signal, and an output terminal configured to output the scanning pulse signal according to the enable input signal and the clock signal when the GOA unit is in the pre-charge stage, the bootstrap output stage and the output decreasing stage, and configured to cut off outputting the scanning pulse signal when the GOA unit is in the reset stage, the first holding stage, the second holding stage and the load-mitigating stage.

In some embodiments of the present disclosure, each GOA unit includes an adjusting unit, a switching device, a first capacitor, and a first node, the adjusting unit is coupled to the enable input terminal and the first node, the switching device is coupled to the first node, the clock signal terminal and the output terminal, the first capacitor is coupled to the first node and the output terminal, and when the GOA unit is in the pre-charge stage, the adjusting unit is configured to adjust a voltage of the first node to a first preset voltage and the switching device is turned on; when the GOA unit is in the bootstrap output stage, the first capacitor is configured to adjust the voltage of the first node from the first preset voltage to a second preset voltage, the switching device is further turned on, and the output terminal is configured to output the scanning pulse signal, in which an absolute value of the second preset voltage is greater than an absolute value of the first preset voltage.

In some embodiments of the present disclosure, the adjusting unit includes a first transistor, a gate and a source of the first transistor are coupled to the enable input terminal, and a drain of the first transistor is coupled to the first node.

In some embodiments of the present disclosure, each GOA unit includes a high level terminal, a reset terminal, a reset unit, a holding unit, a low level terminal, and a second node, and the reset unit is coupled to the high level terminal, the reset terminal and the second node, the holding unit is coupled to the first node, the second node, the output terminal and the low level terminal, and when the GOA unit is in the reset stage, the reset unit is configured to adjust a voltage of the second node to the first preset voltage, the holding unit is configured to clamp the voltage of the first node and a voltage of the output terminal at a third preset voltage, the switching device is turned off, and the output terminal is configured to cut off outputting the scanning pulse signal, in which an absolute value of the third preset voltage is less than the absolute value of the first preset voltage.

In some embodiments of the present disclosure, the switching device includes a third transistor, a gate of the third transistor is coupled to the first node, a source of the third transistor is coupled to the clock signal terminal, and a drain of the third transistor is coupled to the output terminal.

In some embodiments of the present disclosure, the reset unit includes a sixth transistor, a gate of the sixth transistor is coupled to the reset terminal, a source of the sixth transistor is coupled to the high level terminal, and a drain of the sixth transistor is coupled to the second node.

In some embodiments of the present disclosure, the holding unit includes a second transistor and a fifth transistor, a gate of the second transistor is coupled to the second node, a source of the second transistor is coupled to the output terminal, and a drain of the second transistor is coupled to the low level terminal, a gate of the fifth transistor is coupled to the second node, a source of the fifth transistor is connected to the first node, and a drain of the fifth transistor is coupled to the low level terminal.

In some embodiments of the present disclosure, each GOA unit includes a second capacitor, a first end of the second capacitor is coupled to the second node, a second end of the second capacitor is coupled to the low level terminal, and the second capacitor is configured to maintain the voltage of the second node at the first preset voltage.

In some embodiments of the present disclosure, each GOA unit includes a relaxation unit and a relaxation signal terminal, the relaxation unit is coupled to the enable input terminal or the first node, the relaxation signal terminal, the second node and the low level terminal, the relaxation unit is configured to adjust the voltage of the second node to the third preset voltage.

In some embodiments of the present disclosure, the relaxation unit includes a fourth transistor and a seventh transistor, a gate of the fourth transistor is coupled to the enable input terminal or the first node, a source of the fourth transistor is coupled to the second node, a drain of the fourth transistor is coupled to the low level terminal, a gate of the seventh transistor is coupled to the relaxation signal terminal, a source of the seventh transistor is coupled to the second node, and a drain of the seventh transistor is coupled to the low level terminal.

In some embodiments of the present disclosure, the reset terminal is configured to receive a reset signal, and the relaxation signal terminal is configured to receive a relaxation signal, the enable input signal, the clock signal, the reset signal and the relaxation signal each have a duty cycle less than or equal to 25%.

In some embodiments of the present disclosure, an enable input signal of a GOA unit of a current level coincides with a scanning pulse signal of a GOA unit of a previous level.

Embodiments of the present disclosure provide an array substrate, including:

a pixel matrix; and

a GOA circuit configured to provide a scanning pulse signal to a pixel matrix, including a plurality of GOA units in cascade, in which

each GOA unit is configured to work in a pre-charge stage, a bootstrap output stage, an output decreasing stage, a reset stage, a first holding stage, a second holding stage and a load-mitigating stage, and includes:

an enable input terminal configured to receive an enable input signal,

a clock signal terminal configured to receive a clock signal, and

an output terminal configured to output the scanning pulse signal according to the enable input signal and the clock signal when the GOA unit is in the pre-charge stage, the bootstrap output stage and the output decreasing stage, and configured to cut off outputting the scanning pulse signal when the GOA unit is in the reset stage, the first holding stage, the second holding stage and the load-mitigating stage.

In some embodiments of the present disclosure, the pixel matrix includes a plurality of rows of pixels, and an output terminal of a GOA unit of the current level is configured to output the scanning pulse signal to a corresponding row of pixels in the pixel matrix, and the corresponding row of pixels are coupled to an enable input terminal of a GOA unit of a subsequent level.

Embodiments of the present disclosure provide a display device including an array substrate, in which the array substrate includes:

a pixel matrix; and

a GOA circuit, configured to provide a scanning pulse signal to a pixel matrix, including a plurality of GOA units in cascade, in which

each GOA unit is configured to work in a pre-charge stage, a bootstrap output stage, an output decreasing stage, a reset stage, a first holding stage, a second holding stage and a load-mitigating stage, and includes:

an enable input terminal configured to receive an enable input signal,

a clock signal terminal configured to receive a clock signal, and

an output terminal configured to output the scanning pulse signal according to the enable input signal and the clock signal when the GOA unit is in the pre-charge stage, the bootstrap output stage and the output decreasing stage, and configured to cut off outputting the scanning pulse signal when the GOA unit is in the reset stage, the first holding stage, the second holding stage and the load-mitigating stage.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a block diagram of a display device according to an embodiment of the present disclosure.

FIG. 2 is a block diagram of a GOA unit according to an embodiment of the present disclosure.

FIG. 3 is a circuit diagram of a GOA unit according to an embodiment of the present disclosure.

FIG. 4 is a timing sequence diagram of a GOA circuit according to an embodiment of the present disclosure.

FIG. 5 is a schematic diagram of a working waveform of a first stage of a GOA unit according to an embodiment of the present disclosure.

FIG. 6 is a diagram of a working principle of a first stage of a GOA unit according to an embodiment of the present disclosure.

FIG. 7 is a schematic diagram of a working waveform of a second stage of a GOA unit according to an embodiment of the present disclosure.

FIG. 8 is a diagram of a working principle of a second stage of a GOA unit according to an embodiment of the present disclosure.

FIG. 9 is a schematic diagram of a working waveform of a third stage of a GOA unit according to an embodiment of the present disclosure.

FIG. 10 is a diagram of a working principle of a third stage of a GOA unit according to an embodiment of the present disclosure.

FIG. 11 is a schematic diagram of a working waveform of a fourth stage of a GOA unit according to an embodiment of the present disclosure.

FIG. 12 is a diagram of a working principle of a fourth stage of a GOA unit according to an embodiment of the present disclosure.

FIG. 13 is a schematic diagram of a working waveform of a fifth stage of a GOA unit according to an embodiment of the present disclosure.

FIG. 14 is a diagram of a working principle of a fifth stage of a GOA unit according to an embodiment of the present disclosure.

FIG. 15 is a schematic diagram of a working waveform of a sixth stage of a GOA unit according to an embodiment of the present disclosure.

FIG. 16 is a diagram of a working principle of a sixth stage of a GOA unit according to an embodiment of the present disclosure.

FIG. 17 is a schematic diagram of a working waveform of a seventh stage of a GOA unit according to an embodiment of the present disclosure.

FIG. 18 is a diagram of a working principle of a seventh stage of a GOA unit according to an embodiment of the present disclosure.

FIG. 19 is a diagram of a simulation result of a GOA circuit according to an embodiment of the present disclosure.

### REFERENCE NUMERALS

GOA circuit 10, GOA unit 12, adjusting unit 121, switching device 122, reset unit 123, holding unit 124, relaxation unit 125, pixel matrix 20, array substrate 100, display device 1000;

first capacitor C1, second capacitor C2, first transistor M1, second transistor M2, third transistor M3, fourth transistor M4, fifth transistor M5, sixth transistor M6, seventh transistor M7, enable input terminal EN, clock signal terminal CLKB, output terminal OUT, first node PU, second node PD, high level terminal VGH, low level terminal VGL, reset terminal CLKRST, relaxation signal terminal PDRST.

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, and used to generally understand the present disclosure. The embodiments shall not be construed to limit the present disclosure.

In the specification, it is to be understood that terms such as “central”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise” and “counterclockwise” should be construed to refer to the orientation as then described or as shown in the drawings under discussion. These relative terms are for convenience of description and do not require that the present disclosure be constructed or operated in a particular orientation. In addition, terms such as “first” and “second” are used herein for purposes of description and are not intended to indicate or imply relative importance or significance or to imply the number of indicated technical features. Thus, the feature defined with “first” and “second” may include one or more of this feature. In the description of the present disclosure, unless specified otherwise, “a plurality of” means two or more than two.

In the present disclosure, unless specified or limited otherwise, the terms “mounted”, “connected”, “coupled” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on”, “above” or “on top of” a second feature may include an embodiment in which the first feature is right or obliquely “on”, “above” or “on top of” the second feature, or just means that the first feature is at a height higher than that of the second feature; while a first feature “below”, “under” or “on bottom of” a second feature may include an embodiment in which the first feature is right or obliquely “below”, “under” or “on bottom of” the second feature, or just means that the first feature is at a height lower than that of the second feature.

Various embodiments and examples are provided in the following description to implement different structures of the present disclosure. In order to simplify the present disclosure, certain elements and settings will be described. However, these elements and settings are only by way of example and are not intended to limit the present disclosure. In addition, reference numerals may be repeated in different examples in the present disclosure. This repeating is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

Transistors used in all embodiments of the present disclosure may be a field effect transistor, and more specifically may be a thin film transistor (TFT). Since a source and a drain of the transistor used herein are symmetrical, they may be used interchangeably. In order to distinguish the two poles other than the gate of the field effect transistor, it may be determined that an upper end of the field effect transistor is defined as the source, a middle end is defined as the gate, and a lower end is defined as the drain as shown in the drawings.

Unless specified otherwise, following description of the GOA circuit of embodiments of the present disclosure is substantially based on an example in which each transistor (M1 to M7) is an N-type field effect transistor. In a case of a P-type field effect transistor, similar embodiments can be achieved by simply reversing the voltage polarity of the input signal, i.e., the high level is converted to a low level and the low level is converted to a high level. Therefore, embodiments of the present disclosure are not limited to the embodiments of the N-type field effect transistors.

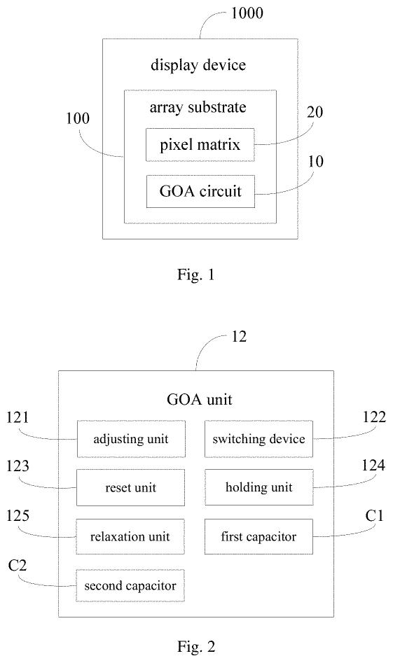

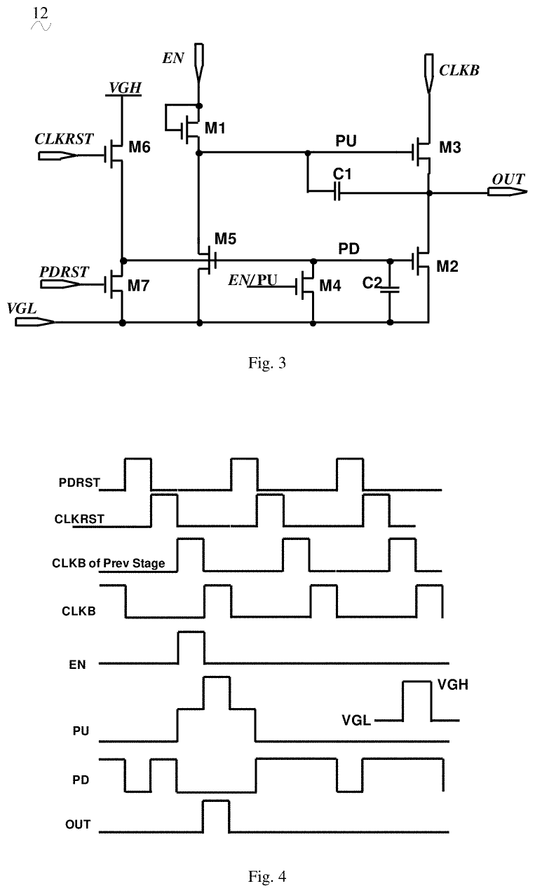

With reference to FIGS. 1 to 3, in an embodiment of the present disclosure, a GOA circuit 10 is configured to provide a scanning pulse signal to a pixel matrix 20, and includes a plurality of GOA units 12 in cascade. Each GOA unit 12 has a shutdown mechanism including an active state and an inactive state. Each GOA unit 12 includes: an enable input terminal EN configured to receive an enable input signal, a clock signal terminal CLKB configured to receive a clock signal, and an output terminal OUT configured to output the scanning pulse signal according to the enable input signal and the clock signal when the shutdown mechanism is in the inactive state, and configured to cut off outputting the scanning pulse signal when the shutdown mechanism is in the active state.

In the GOA circuit 10 according to an embodiment of the present disclosure, the shutdown mechanism is in the inactive state in a period in which a scanning pulse signal is required to be generated, and is in the active state in the rest of time. On this basis, conduction and amplification path of generating false triggers are blocked, thus effectively avoiding the false trigger of the GOA circuit 10.

In an embodiment, the array substrate 100 of the present disclosure includes a pixel matrix 20 and a GOA circuit 10.

In an embodiment, the array substrate 100 of the present disclosure may be used for the display device 1000 of the present disclosure. In other words, in an embodiment, the display device of the present disclosure includes the array substrate 100 of the present disclosure.

In some embodiments, the display device 1000 may be a display device such as LCD or an AMOLED.

In some embodiments, the pixel matrix 20 includes a plurality of rows of pixels. An output terminal OUT of a GOA unit 12 of each level is configured to output the scanning pulse signal to a corresponding row of pixels in the pixel matrix 20, and the corresponding row of pixels are coupled to an enable input terminal EN of a GOA unit 12 of a subsequent level.

In an embodiment, GOA units 12 of two adjacent levels are disposed at two sides of the pixel matrix 20, respectively.

In some embodiments, each GOA unit 12 includes an adjusting unit 121, a switching device 122, a first capacitor C1, and a first node PU. The adjusting unit 121 is coupled to the enable input terminal EN and the first node PU. The switching device 122 is coupled to the first node PU, the clock signal terminal CLKB and the output terminal OUT. The first capacitor C1 is coupled to the first node PU and the output terminal OUT. When the shutdown mechanism is in the inactive state, the adjusting unit 121 is configured to adjust a voltage of the first node PU to a first preset voltage and the switching device 122 is turned on to a certain degree. The first capacitor C1 is configured to further adjust the voltage of the first node PU from the first preset voltage to a second preset voltage, the switching device 122 is turned on to a greater degree, and the output terminal OUT is configured to output the scanning pulse signal. An absolute value of the second preset voltage is greater than an absolute value of the first preset voltage.

In an embodiment, an N-type field effect transistor is applied in each transistor. The adjusting unit 121 is configured to charge the first node PU, such that the voltage of the first node PU is increased to the first preset voltage VGH. At this time, the adjusting unit 121 functions to pull up the voltage. For example, the first preset voltage is 2 V. The first capacitor C1 is configured to increase the voltage of the first node PU from the first preset voltage to the second preset voltage, for example, the second set voltage is 3 V.

It can be understood that the first capacitor C1 is a bootstrap capacitor. The voltage of the first node PU is increased by 2(VGH−VGL) caused by the enable input terminal EN and the first capacitor C1 together, the switching device 122 is turned on to a greater degree, and the output terminal OUT is configured to output a scanning pulse signal. Specifically, VGH is the first preset voltage, (2VGH−VGL) is the second preset voltage, and VGL is a third preset voltage. The first preset voltage VGH may be a high level voltage, and the third preset voltage VGL may be a low level voltage.

In another embodiment, a P-type field effect transistor is applied in each transistor. The adjusting unit 121 is configured to discharge the first node PU, such that the voltage of the first node PU is decreased to the first preset voltage VGH. At this time, the adjusting unit 121 functions to pull down the voltage. For example, the first preset voltage VGH is −2 V. The first capacitor C1 is configured to decrease the voltage of the first node PU from the first preset voltage VGH to the second preset voltage (2VGH−VGL). For example, the second preset voltage (2VGH−VGL) is −3 V. No more detail is described herein to avoid repetition.

In some embodiments, the adjusting unit 121 includes a first transistor M1. A gate and a source of the first transistor M1 are coupled to the enable input terminal EN, and a drain of the first transistor M1 is coupled to the first node PU.

When the shutdown mechanism is in the inactive state, the first node PU is charged by the enable input signal through the first transistor M1, such that the voltage of the first node PU is increased to the first preset voltage VGH, thus turning on the switching device 122 to complete the preparation of outputting the scanning pulse.

In some embodiments, each GOA unit includes a high level terminal VGH, a reset terminal CLKRST, a reset unit 123, a holding unit 124, a low level terminal VGL, and a second node PD. The reset unit 123 is coupled to the high level terminal VGH, the reset terminal CLKRST and the second node PD. The holding unit 124 is coupled to the first node PU, the second node PD, the output terminal OUT and the low level terminal VGL. When the shutdown mechanism is in the active state, the reset unit 123 is configured to adjust a voltage of the second node PD to the first preset voltage VGH. The holding unit 124 is configured to clamp the voltage of the first node PU and a voltage of the output terminal OUT at a third preset voltage VGL. The switching device 122 is turned off, and the output terminal OUT is configured to cut off outputting the scanning pulse signal. Specifically, an absolute value of the third preset voltage VGL is less than the absolute value of the first preset voltage VGH.

In an embodiment, an N-type field effect transistor is applied in each transistor. The reset unit 123 is configured to charge the second node PD, such that the voltage of the second node PD is increased to the first preset voltage VGH. At this time, the reset unit 123 functions to pull up the voltage. For example, the first preset voltage VGH is 2V. The holding unit 124 is configured to discharge the first node PU and the output terminal OUT, such that the voltage of the first node PU and the voltage of the output terminal OUT are clamped at the third preset voltage VGL, for example, the third preset voltage VGL may be 1 V.

When the shutdown mechanism is in the active state, the switch device 122 is turned off, a small floating generated from a previous level is transmitted to the ground by the holding unit 124, such that turning-off degree of the switching device 122 of the current level is not effected by the floating. On this basis, conduction and amplification path of generating false triggers are blocked, thus effectively avoiding the false trigger caused by the parasitic effect.

In another embodiment, a P-type field effect transistor is applied in each transistor. The reset unit 123 is configured to discharge the second node PD, such that the voltage of the second node PD is decreased to the first preset voltage VGH. At this time, the reset unit 123 functions to pull down the voltage. For example, the first preset voltage VGH is −2V. The holding unit 124 is configured to charge the first node PU and the output terminal OUT, such that the voltage of the first node PU and the voltage of the output terminal OUT are clamped at the third preset voltage VGL, for example, the third preset voltage VGL may be −1 V. No more detail is described herein to avoid repetition.

In some embodiments, the switching device 122 includes a third transistor M3. A gate of the third transistor M3 is coupled to the first node PU, a source of the third transistor M3 is coupled to the clock signal terminal CLKB, and a drain of the third transistor M3 is coupled to the output terminal OUT.

Since the charging and discharging of the output terminal OUT are performed by the third transistor M3, the GOA unit 12 of each level only needs one large-sized third transistor M3, and thus the occupied area of the GOA unit 12 is optimized. Moreover, the high current flowing through the third transistor M3 alternates in two directions, and the metal electrode of the third transistor M3 is less prone to electrical migration, thus improving the reliability of the GOA circuit 10.

In some embodiment, the reset unit 123 includes a sixth transistor M6. A gate of the sixth transistor M6 is coupled to the reset terminal CLKRST, a source of the sixth transistor M6 is coupled to the high level terminal VGH, and a drain of the sixth transistor M6 is coupled to the second node PD.

In other words, the sixth transistor M6 is configured to charge the second node PD, such that the voltage of the second node PD is increased to the first preset voltage VGH, thus the holding unit 124 is turned on and the shutdown mechanism is activated to enter the active state.

In some embodiments, the holding unit 124 includes a second transistor M2 and a fifth transistor M5. A gate of the second transistor M2 is coupled to the second node PD, a source of the second transistor M2 is coupled to the output terminal OUT, and a drain of the second transistor M2 is coupled to the low level terminal VGL. A gate of the fifth transistor M5 is coupled to the second node PD, a source of the fifth transistor M5 is connected to the first node PU, and a drain of the fifth transistor M5 is coupled to the low level terminal VGL.

Specifically, the second transistor M2 is configured to discharge the output terminal OUT, such that the voltage of the output terminal OUT is clamped at the third preset voltage VGL. The fifth transistor M5 is configured to discharge the first node PU, such that the voltage of the first node PU is clamped at the third preset voltage VGL.

On this basis, voltage glitches generated from the clock signal terminal CLKB and fed forward to the output terminal OUT through the switching device 122 is released by the second transistor M2, and voltage glitches generated from the clock signal terminal CLKB of a previous level GOA unit 12 and transmitted to an enable input terminal EN of the current level GOA unit 12 is released by the fifth transistor M5.

In some embodiments, each GOA unit 12 includes a second capacitor C2. A first end of the second capacitor C2 is coupled to the second node PD, a second end of the second capacitor C2 is coupled to the low level terminal VGL, and the second capacitor C2 is configured to maintain the voltage of the second node PD at the first preset voltage VGH.

In some embodiments, each GOA unit 12 includes a relaxation unit 125 and a relaxation signal terminal PDRST. The relaxation unit 125 is coupled to the enable input terminal EN or the first node PU, the relaxation signal terminal PDRST, the second node PD and the low level terminal VGL. The relaxation unit 125 is configured to adjust the voltage of the second node PD to the third preset voltage VGL.

In an embodiment, an N-type field effect transistor is applied in each transistor. The relaxation unit 125 is configured to discharge the second node PD, such that the voltage of the second node PD is reduced to the third preset voltage VGL. At this time, the relaxation unit 125 functions to pull down the voltage. For example, the third preset voltage VGL is 1 V.

On this basis, the relaxation unit 125 may be helpful to mitigate the load of the second node PD. Moreover, when the holding unit 124 includes the second transistor M2 and the fifth transistor M5, the relaxation unit 125 is configured to discharge the second node PD, such that the gate voltages of the second transistor M2 and the fifth transistor M5 are released, which is advantageous for reducing the drift of the threshold voltages of the second transistor M2 and the fifth transistor M5, thus extending working life.

In another embodiment, a P-type field effect transistor is applied in each transistor. The relaxation unit 125 is configured to charge the second node PD, such that the voltage of the second node PD is increased to the third preset voltage VGL. At this time, the relaxation unit 125 functions to pull up the voltage. For example, the third preset voltage is −1 V. No more detail is described herein to avoid repetition.

In some embodiments, the relaxation unit 125 includes a fourth transistor M4 and a seventh transistor M7. A gate of the fourth transistor M4 is coupled to the enable input terminal EN or the first node PU, a source of the fourth transistor M4 is coupled to the second node PD, a drain of the fourth transistor M4 is coupled to the low level terminal VGL. A gate of the seventh transistor M7 is coupled to the relaxation signal terminal PDRST, a source of the seventh transistor M7 is coupled to the second node PD, and a drain of the seventh transistor M7 is coupled to the low level terminal VGL.

In some embodiments, the reset terminal CLKRST is configured to receive a reset signal, and the relaxation signal terminal PDRST is configured to receive a relaxation signal, the enable input signal, the clock signal, the reset signal and the relaxation signal each have a duty cycle less than or equal to 25%.

As shown in FIG. 4, in an embodiment, the enable input signal, the clock signal, the reset signal and the relaxation signal each have a duty cycle less than or equal to 25%. The enable input signal, the clock signal, the relaxation signal and the reset signal are high level signal in turn. Specifically, in an embodiment of the present disclosure, in the first stage, the enable input signal is a high level signal. In the second stage, the clock signal is a high level signal. In the third stage, the relaxation signal is a high level signal. In the fourth stage, the reset signal is high level signal. Division of specific stages will be described in detail below.

In some embodiments, the enable input signal is configured to turn on the output transistor (third transistor M3) of a current level, and thus the enable input signal can firstly output a high level signal to complete the preparation. The clock terminal, the relaxation terminal, and the reset terminal sequentially output a high level signal after the enable input signal to complete the bootstrap output. On this basis, scanning pulse signal is output, and the output transistor is turned off after the scanning pulse signal is output, thus blocking the subsequent clock signal from passing through. In this way, the expected output voltages of the first node PU, the second node PD and the output terminal OUT as shown in FIG. 4 can be obtained.

In some embodiments, an enable input signal of a GOA unit 12 of a current level coincides with a scanning pulse signal of a GOA unit 12 of a previous level.

Specifically, in an embodiment of the present disclosure, the enable input signal of the GOA unit 12 of the current level and the scanning pulse signal of the GOA unit 12 of the previous level are both high level signal in the first stage. Division of specific stages will be described in detail below.

It can be understood that an output terminal OUT of a GOA unit 12 of each level is configured to output the scanning pulse signal to a corresponding row of pixels in the pixel matrix 20, and the corresponding row of pixels are coupled to an enable input terminal EN of a GOA unit 12 of a subsequent level. In other words, a scanning pulse signal of a GOA unit 12 of a previous level is used as the scanning signal of a previous row of pixels, and is also used as a preparation signal of a GOA unit 12 of a current level.

Working principle in different stages of the GOA circuit 10 according to an embodiment of the present disclosure is described below.

First Stage: A Pre-Charge Stage

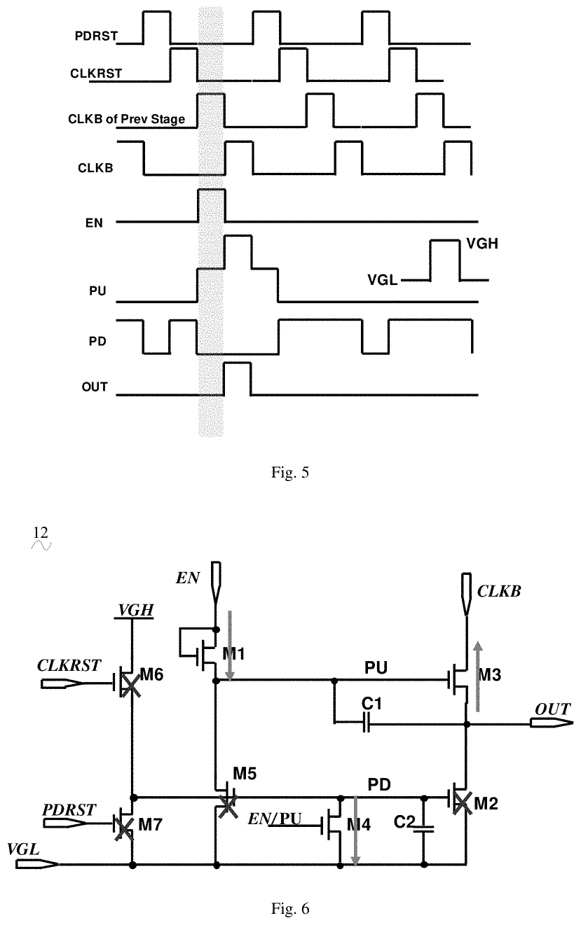

With reference to FIG. 5 and FIG. 6, the voltage of the first node PU is increased by the enable input signal to the first preset voltage VGH. The fourth transistor M4 is turned on by the enable input signal, and the second node PD is discharged through the fourth transistor M4 by the enable input signal. The third transistor M3 is turned on, and the output terminal OUT is ready to output the scanning pulse signal.

Second Stage: A Bootstrap Output Stage

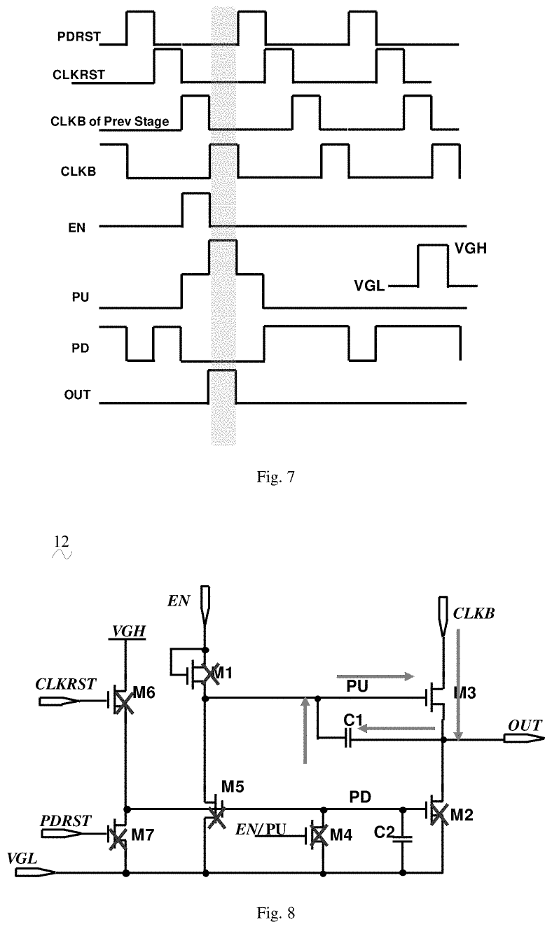

With reference to FIG. 7 and FIG. 8, the voltage of the output terminal OUT is increased to the first preset voltage VGH by the clock signal. The voltage of the first node PU is increased to the second preset voltage (2VGH−VGL) by the first capacitor C1. The third transistor M3 is further turned on, such that the output terminal OUT is quickly charged by the clock signal terminal CLKB and the scanning pulse signal is output by the output terminal OUT.

Third Stage: An Output Decreasing Stage

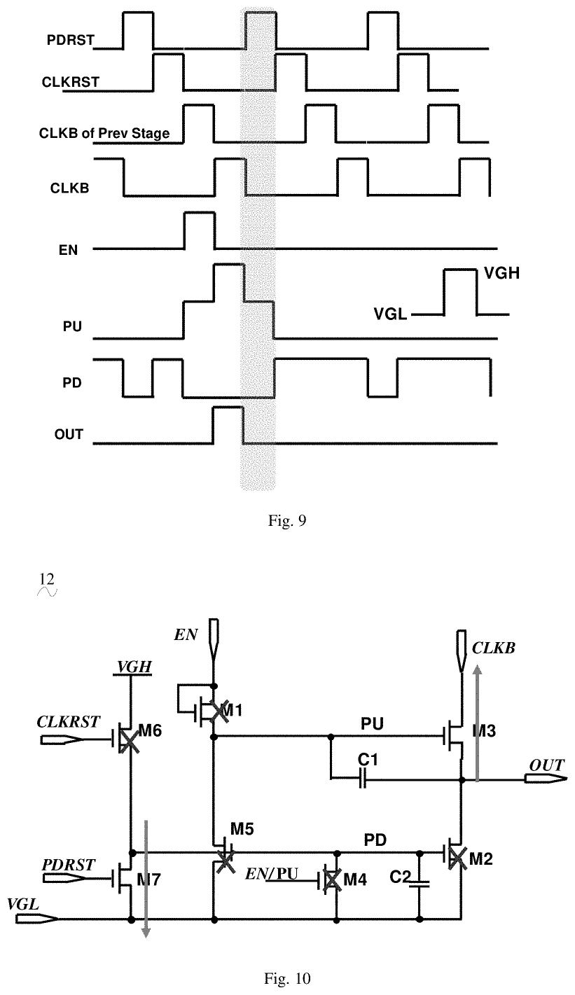

With reference to FIG. 9 and FIG. 10, the third transistor M3 continues to be turned on. When the voltage of the clock signal terminal CLKB falls back, the third transistor M3 is discharged to the output terminal OUT, such that the voltage of the output terminal OUT falls back to the third preset voltage VGL with the clock signal terminal CLKB. The seventh transistor M7 is turned on by the relaxation signal, such that the second node PD remains at the third preset voltage VGL.

Since the charging and discharging of the output terminal OUT are performed by the third transistor M3, the GOA unit 12 of each level only needs one large-sized third transistor M3, and thus the occupied area of the GOA unit 12 is optimized. Moreover, the high current flowing through the third transistor M3 alternates in two directions, the metal electrode of the third transistor M3 is less prone to electrical migration, thus improving the reliability of the GOA circuit 10.

It can be understood that in the first stage, the second stage and the third stage, the shutdown mechanism is in the inactive state.

Fourth Stage: A Reset Stage of the First Node PU

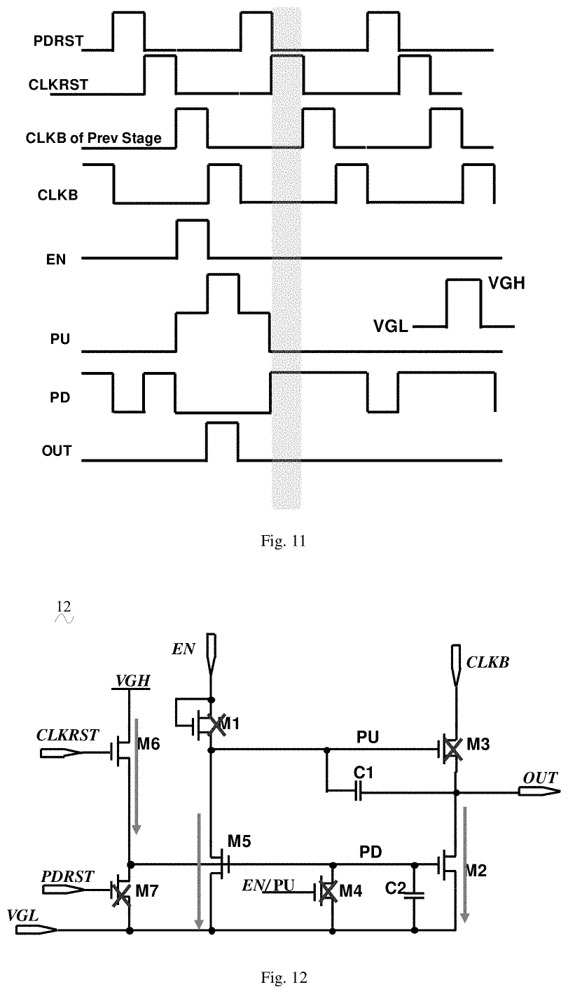

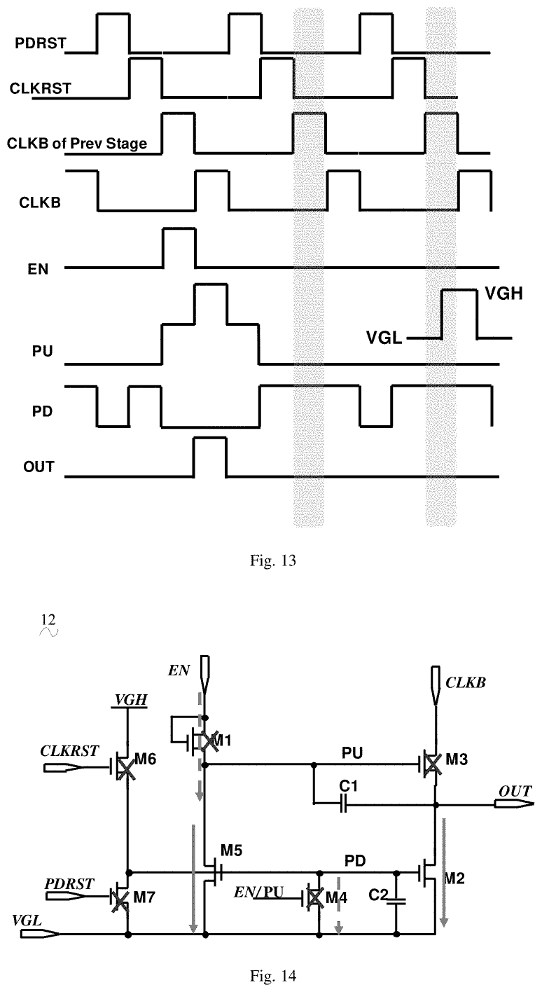

With reference to FIG. 11 and FIG. 12, the sixth transistor M6 is turned on by the reset signal. The second node PD is charged by the sixth transistor M6, and the voltage of the second node PD is increased to the first preset voltage VGH. The second transistor M2 and the fifth transistor M5 are turned on, and the shutdown mechanism is activated. The first node PU is discharged by the fifth transistor M5, the voltage of the first node PU is reset to the third preset voltage VGL, and the third transistor M3 is turned off. The second transistor M2 is configured to maintain the output terminal OUT at the third preset voltage.

Fifth Stage: A First Holding Stage

With reference to FIG. 13 and FIG. 14, the second capacitor C2 is configured to maintain the second node PD at the first preset voltage VGH, the second transistor M2 is configured to maintain the output terminal OUT at the third preset voltage VGL, and the fifth transistor M5 is configured to maintain the first node PU at the third preset voltage VGL.

The voltage glitches generated from the clock signal terminal CLKB of the previous level and transmitted to the enable input terminal EN of the current level is released by the fifth transistor M5, and thus the voltage of the first node PU of the GOA unit in the current level will not be increased.

In other words, the turned-on fifth transistor M5 and the first capacitor C1 together form a first-order low-pass filter that thus high-frequency glitch current signal from the enable input terminal EN is filtered out.

It can be understood that after the third stage, the fourth stage, the fifth stage, the sixth stage, and the seventh stage will be continuously and alternately performed, and repeated in cycle, i.e., the third stage, the fourth stage, the fifth stage, the sixth stage, the seventh stage, the fourth stage, the fifth stage, the sixth stage, the seventh stage, the fourth stage, the fifth stage, the sixth stage, the seventh stage. . . . Therefore, the first fourth stage is performed after the third stage, the other fourth stages are performed after the seventh stage. In the fourth stage performed in cycle, the first node PU and the output terminal OUT are clamped at the third preset voltage VGL. The first fourth stage performed after the third stage is slightly different from others in that the first node PU is discharged to the third preset voltage VGL in the first fourth stage, the first node PU is maintained at the third preset voltage VGL in the other fourth stage in cycle.

Sixth Stage: A Second Holding Stage

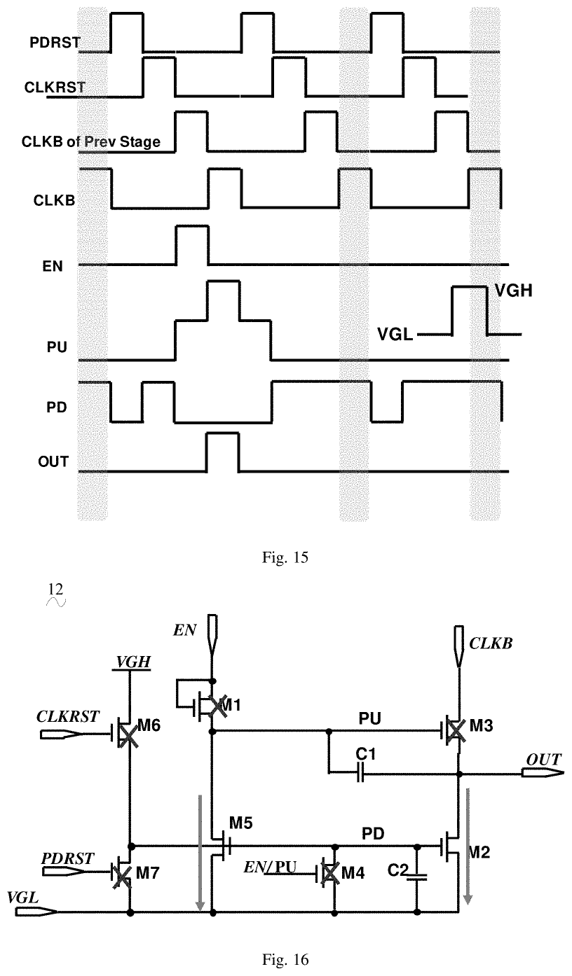

With reference to FIG. 15 and FIG. 16, the second capacitor C2 is configured to maintain the second node PD at the first preset voltage VGH, the second transistor M2 is configured to maintain the output terminal OUT at the third preset voltage VGL, and the fifth transistor M5 is configured to maintain the first node PU at the third preset voltage VGL.

The voltage glitches generated from the clock signal terminal CLKB and fed forward to the output terminal OUT is released by the second transistor M2.

Seventh Stage: A Load-Mitigating Stage of the Second Node PD

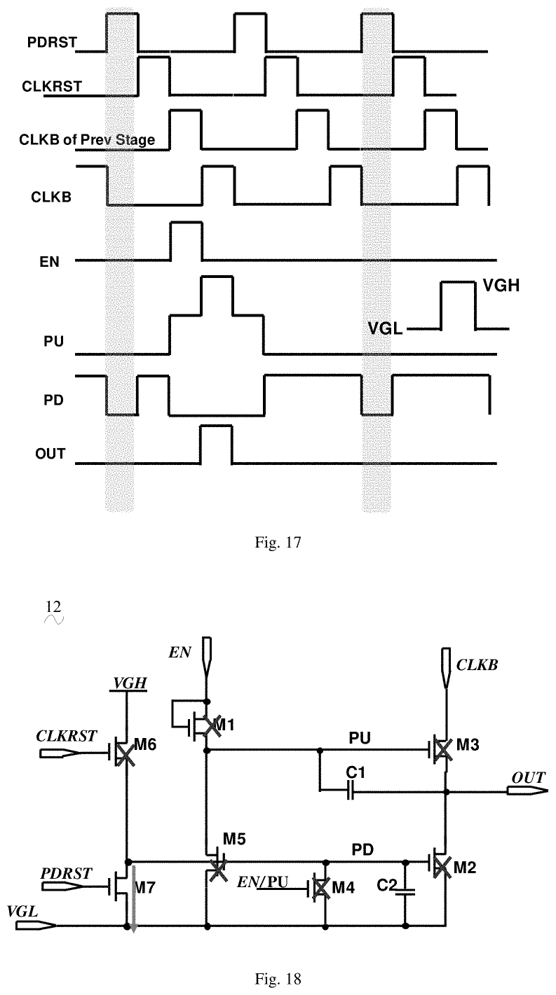

With reference to FIG. 17 and FIG. 18, the seventh transistor M7 is turned on by the relaxation signal, and the second node PD is discharged by the seventh transistor M7.

The gate voltages of the second transistor M2 and the fifth transistor M5 are released, thus reducing the drift of the threshold voltages and extending working life.

It can be understood that the shutdown mechanism is activated in the fourth stage, and the shutdown mechanism is in the active state in the fifth stage and the sixth stage.

On this basis, the fourth stage, the fifth stage, the sixth stage and the seventh stage are repeated in cycle, the voltages of the first node PU and the output terminal OUT are clamped at the third preset voltage VGL.

The first stage is performed again when a next frame of the scanning pulse signal arrives.

It should be noted that, in the circuit diagram shown in the drawings, “X” marked on the transistor indicates that the transistor is in a cut-off state.

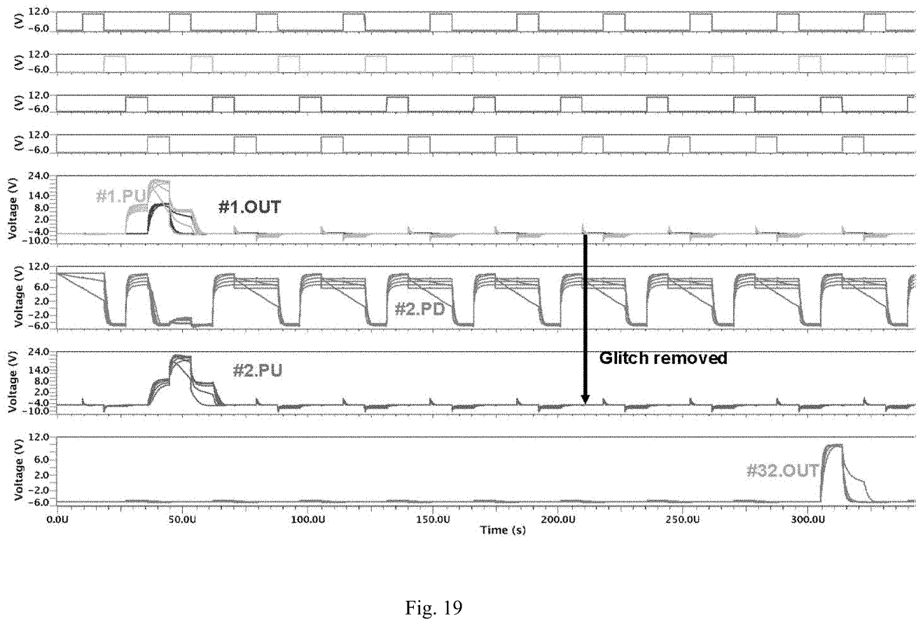

With reference to FIG. 19, a diagram of a simulation result of a GOA circuit 10 according to an embodiment of the present disclosure is shown. When the output terminal OUT has a load, and the GOA circuit 10 can work normally even if the voltage of the output terminal OUT shifts from −2 V to +3 V. Output glitch generated from the GOA unit 12 in the previous level is not accumulated on the first node PU of the GOA unit 12 in the current level, but is discharged by the second node PD through the fifth transistor M5.

In summary, the GOA circuit 10 of the embodiments of the present disclosure has the following advantages.

1. A new shutdown mechanism is provided by modifying the inner circuit design and using a new timing sequence diagram according to embodiments of the present disclosure. The shutdown mechanism is in the inactive state during the period in which the scanning pulse signal needs to be generated, and is in the active state in the rest of the time. When the shutdown mechanism is in the active state, the small floating output from the previous level can be directly transmitted to the ground, such that a closing degree of the output transistor (i.e., the third transistor M3) of the current level will not be affected by the floating. On this basis, conduction and amplification path of generating false triggers are blocked, thus effectively avoiding the false trigger caused by the parasitic effect.

2. The number of transistors required for the GOA circuit 10 of the embodiments of the present disclosure is relatively small, and the size of each transistor required is not large. Therefore, the occupied area is small, which is advantageous for reducing the size of the screen frame.

3. The GOA circuit 10 of the embodiments of the present disclosure does not have a node that maintains at a constant high voltage for a long time. Compared with a circuit having a node at a constant high voltage, the GOA circuit 10 of the embodiments of the present disclosure has a relatively low load on the transistors, which is advantageous for improving the stability of the GOA circuit 10 and the screen display.

4. The transistor (i.e., the third transistor M3) responsible for driving the output load in the GOA circuit 10 of the embodiments of the present disclosure is used for both charging and discharging, and a bidirectional current passes through the transistor, thus avoiding the electro-migration caused by continuous collision of electrons to the lattice in a single direction and extending the working life of the circuit.

Reference throughout this specification to “an embodiment”, “some embodiments”, “a schematic embodiment”, “an example”, “a specific example” or “some examples” means that a particular feature, structure, material, or characteristic described in connection with the embodiment or example is included in at least one embodiment or example of the present disclosure. Thus, the appearances of the phrases such as “an embodiment”, “some embodiments”, “a schematic embodiment”, “an example”, “a specific example” or “some examples” in various places throughout this specification are not necessarily referring to the same embodiment or example of the present disclosure. Furthermore, the particular features, structures, materials, or characteristics may be combined in any suitable manner in one or more embodiments or examples.

It will be understood that, any process or method described in a flow chart or described herein in other manners may include one or more modules, segments or portions of codes that include executable instructions to implement the specified logic function(s) or that includes executable instructions of the steps of the progress. Although the flow chart shows a specific order of execution, it is understood that the order of execution may differ from that which is depicted. For example, the order of execution of two or more boxes may be scrambled relative to the order shown. Also, two or more boxes shown in succession in the flow chart may be executed concurrently or with partial concurrence.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system including processors or other systems capable of obtaining the instruction from the instruction execution system, device and equipment and executing the instruction), or to be used in combination with the instruction execution system, device and equipment. As to the specification, the “computer readable medium” may be any device adaptive for including, storing, communicating, propagating or transferring programs to be used by or in combination with the instruction execution system, device or equipment. More specific examples of the computer readable medium include but are not limited to: an electronic connection (an IPM overcurrent protection circuit) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs include one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1-15. (canceled)

16. A gate driver on array (GOA) circuit, configured to provide a scanning pulse signal to a pixel matrix, comprising a plurality of GOA units in cascade, wherein
each GOA unit is configured to work in a pre-charge stage, a bootstrap output stage, an output decreasing stage, a reset stage, a first holding stage, a second holding stage and a load-mitigating stage, and comprises:
an enable input terminal configured to receive an enable input signal,
a clock signal terminal configured to receive a clock signal, and
an output terminal configured to output the scanning pulse signal according to the enable input signal and the clock signal when the GOA unit is in the pre-charge stage, the bootstrap output stage and the output decreasing stage, and configured to cut off outputting the scanning pulse signal when the GOA unit is in the reset stage, the first holding stage, the second holding stage and the load-mitigating stage.

17. The GOA circuit according to claim 16, wherein each GOA unit comprises an adjusting unit, a switching device, a first capacitor, and a first node, the adjusting unit is coupled to the enable input terminal and the first node, the switching device is coupled to the first node, the clock signal terminal and the output terminal, the first capacitor is coupled to the first node and the output terminal, and
when the GOA unit is in the pre-charge stage, the adjusting unit is configured to adjust a voltage of the first node to a first preset voltage and the switching device is turned on;
when the GOA unit is in the bootstrap output stage, the first capacitor is configured to adjust the voltage of the first node from the first preset voltage to a second preset voltage, the switching device is further turned on, and the output terminal is configured to output the scanning pulse signal, wherein an absolute value of the second preset voltage is greater than an absolute value of the first preset voltage.

18. The GOA circuit according to claim 17, wherein the adjusting unit comprises a first transistor, a gate and a source of the first transistor are coupled to the enable input terminal, and a drain of the first transistor is coupled to the first node.

19. The GOA circuit according to claim 17, wherein each GOA unit comprises a high level terminal, a reset terminal, a reset unit, a holding unit, a low level terminal, and a second node, and the reset unit is coupled to the high level terminal, the reset terminal and the second node, the holding unit is coupled to the first node, the second node, the output terminal and the low level terminal, and
when the GOA unit is in the reset stage, the reset unit is configured to adjust a voltage of the second node to the first preset voltage, the holding unit is configured to clamp the voltage of the first node and a voltage of the output terminal at a third preset voltage, the switching device is turned off, and the output terminal is configured to cut off outputting the scanning pulse signal, wherein an absolute value of the third preset voltage is less than the absolute value of the first preset voltage.

20. The GOA circuit according to claim 17, wherein the switching device comprises a third transistor, a gate of the third transistor is coupled to the first node, a source of the third transistor is coupled to the clock signal terminal, and a drain of the third transistor is coupled to the output terminal.

21. The GOA circuit according to claim 19, wherein the reset unit comprises a sixth transistor, a gate of the sixth transistor is coupled to the reset terminal, a source of the sixth transistor is coupled to the high level terminal, and a drain of the sixth transistor is coupled to the second node.

22. The GOA circuit according to claim 19, wherein the holding unit comprises a second transistor and a fifth transistor, a gate of the second transistor is coupled to the second node, a source of the second transistor is coupled to the output terminal, and a drain of the second transistor is coupled to the low level terminal, a gate of the fifth transistor is coupled to the second node, a source of the fifth transistor is connected to the first node, and a drain of the fifth transistor is coupled to the low level terminal.

23. The GOA circuit according to claim 19, wherein each GOA unit comprises a second capacitor, a first end of the second capacitor is coupled to the second node, a second end of the second capacitor is coupled to the low level terminal, and the second capacitor is configured to maintain the voltage of the second node at the first preset voltage.

24. The GOA circuit according to claim 19, wherein each GOA unit comprises a relaxation unit and a relaxation signal terminal, the relaxation unit is coupled to the enable input terminal or the first node, the relaxation signal terminal, the second node and the low level terminal, the relaxation unit is configured to adjust the voltage of the second node to the third preset voltage.

25. The GOA circuit according to claim 24, wherein the relaxation unit comprises a fourth transistor and a seventh transistor, a gate of the fourth transistor is coupled to the enable input terminal or the first node, a source of the fourth transistor is coupled to the second node, a drain of the fourth transistor is coupled to the low level terminal, a gate of the seventh transistor is coupled to the relaxation signal terminal, a source of the seventh transistor is coupled to the second node, and a drain of the seventh transistor is coupled to the low level terminal.

26. The GOA circuit according to claim 25, wherein the reset terminal is configured to receive a reset signal, and the relaxation signal terminal is configured to receive a relaxation signal, the enable input signal, the clock signal, the reset signal and the relaxation signal each have a duty cycle less than or equal to 25%.

27. The GOA circuit according to claim 16, wherein an enable input signal of a GOA unit of a current level coincides with a scanning pulse signal of a GOA unit of a previous level.

28. An array substrate, comprising:
a pixel matrix; and
a GOA circuit, configured to provide a scanning pulse signal to a pixel matrix, comprising a plurality of GOA units in cascade, wherein
each GOA unit is configured to work in a pre-charge stage, a bootstrap output stage, an output decreasing stage, a reset stage, a first holding stage, a second holding stage and a load-mitigating stage, and comprises:
an enable input terminal configured to receive an enable input signal,
a clock signal terminal configured to receive a clock signal, and
an output terminal configured to output the scanning pulse signal according to the enable input signal and the clock signal when the GOA unit is in the pre-charge stage, the bootstrap output stage and the output decreasing stage, and configured to cut off outputting the scanning pulse signal when the GOA unit is in the reset stage, the first holding stage, the second holding stage and the load-mitigating stage.

29. The array substrate according to claim 28, wherein the pixel matrix comprises a plurality of rows of pixels, and an output terminal of a GOA unit of the current level is configured to output the scanning pulse signal to a corresponding row of pixels in the pixel matrix, and the corresponding row of pixels are coupled to an enable input terminal of a GOA unit of a subsequent level.

30. A display device comprising an array substrate, wherein
the array substrate comprises:
a pixel matrix; and
a GOA circuit, configured to provide a scanning pulse signal to a pixel matrix, comprising a plurality of GOA units in cascade, wherein
each GOA unit is configured to work in a pre-charge stage, a bootstrap output stage, an output decreasing stage, a reset stage, a first holding stage, a second holding stage and a load-mitigating stage, and comprises:
an enable input terminal configured to receive an enable input signal,
a clock signal terminal configured to receive a clock signal, and
an output terminal configured to output the scanning pulse signal according to the enable input signal and the clock signal when the GOA unit is in the pre-charge stage, the bootstrap output stage and the output decreasing stage, and configured to cut off outputting the scanning pulse signal when the GOA unit is in the reset stage, the first holding stage, the second holding stage and the load-mitigating stage.

31. The GOA circuit according to claim 19, wherein the switching device comprises a third transistor, a gate of the third transistor is coupled to the first node, a source of the third transistor is coupled to the clock signal terminal, and a drain of the third transistor is coupled to the output terminal.
